(19) United States
(12) Patent Application Publication
(10) Pub. No.: US 2011/0001787 A1
(43) Pub. Date: Jan. 6, 2011

(54) DEVICE FOR ERASING USED INK RIBBON

(75) Inventors: Qingbang Xu, Weihai (CN); Mingdong Huang, Weihai (CN); Guoqiang Wang, Weihai (CN)

Correspondence Address: INTELLECTUAL PROPERTY / TECHNOLOGY LAW, PO BOX 14329, RESEARCH TRIANGLE PARK, NC, 27709, US

(73) Assignee: Shandong New Beiyang Information Technology Co., Ltd.

(21) Appl. No.: 12/920,074

(22) PCT Filed: Jun. 19, 2008
(86) PCT No.: PCT/CN08/71365

§ 371 Date: Aug. 27, 2010

(30) Foreign Application Priority Data
Mar. 11, 2008 (CN) 200820005602.6

(51) Int. Cl. B41J 2/325

(52) U.S. Cl. 347/179

(57) ABSTRACT

A device for erasing a used ink ribbon comprises a heater. The heater is provided on a dye layer side of the ink ribbon at the downstream of a printing apparatus and contacts with the dye layer of the ink ribbon. The information remaining on the used ink ribbon can be erased through directly melting and eliminating the dye on the ink ribbon by the heater. The present invention makes the recycle of the used ink ribbon be safer and more reliable, and effectively prevent confidential or private information from being divulged by the discarded used ink ribbon.

The present application claims the priority of the Chinese patent application No. 200820005602.6 filed with the Chinese Patent Office on Mar. 11, 2008 and entitled “An Erasing Device for Used Ink Ribbon”, and all the contents thereof are incorporated by reference into the present application.

### FIELD OF THE INVENTION

The present invention relates to the field of printing mechanical technologies, especially to thermal transfer/thermal sublimation printers, and specifically, to a device for erasing a used ink ribbon.

### BACKGROUND ART

Thermal transfer refers to transferring a dye coating on an ink ribbon to paper or other printing mediums using a dedicated ink ribbon in the manner of heating. The dye coating substance on the ink ribbon has a relatively strong adhesion force, thereby preventing the printed characters or patterns from being affected by external factors, that is, the characters can be kept for a long time and will not fade, and the colors or shapes thereof will not change even in a high ambient temperature or in contact with a solvent. Based on the above features of the thermal transfer technology, thermal transfer printers have been widely used in the printing and producing field of marks and labels such as bar code, train ticket and boarding card.

After a thermal transfer printer finishes printing, the image of the printed characters or patterns will be left on the used ink ribbon; in general situations, after an ink ribbon is used up, a printer ink ribbon recycling winding up roller including the used ink ribbon will be discarded directly. Thus, other persons would read the character or pattern information remaining on the discarded ink ribbon and thus can know the printed contents, which results in that printed confidential documents or personal information are divulged.

To solve this problem, a Japanese patent with the publication number of JP63230386 provides a device for erasing a used ink ribbon, and referring to FIG. 1, the device mainly comprises a heating roller 10 and a scraper 11 disposed opposite to each other, wherein the heating roller 10 is disposed at the base side of the ink ribbon; the scraper 11 is disposed at the dye side of the ink ribbon. As shown in the figure, 4a is the unprinted segment of a printing medium, and 4b is the printed segment of the printing medium; 5a is the unused segment of the ink ribbon, 5b is the used segment of the ink ribbon, and 5c is an erased segment of the ink ribbon; 9a is an unused dye layer of the ink ribbon, 9b is the dye layer adhered to the printing medium, and 9c is the information remaining on the used ink ribbon. The working process of the device is described as follows: when the used segment 5b of the ink ribbon is passing the heating roller 10, the dye layer of the remaining information 9c adhered thereto is heated and then melted; then the melted dye layer is scraped by the scraper 11, and most of the dye falls into a receiving plate (not shown); now only a little dye is left on the erased segment 5c of the ink ribbon and then the original information cannot be read, and the erased ink ribbon is recycled by a recycling roller (not shown in the figure). Hence, the problem is avoided that the secret information on the discarded used ink ribbon is divulged.

However, during practical use, the scraper 11 easily damages the ink ribbon, which affects recycling the ink ribbon by the recycling roller; meanwhile, the receiving plate needs to be cleaned periodically, which increases the maintenance work of the thermal transfer printer.

### SUMMARY OF THE INVENTION

The present invention provides a device for erasing a used ink ribbon which can prevent the secret or privacy from being divulged by the discarded used ink ribbon, so that the ink ribbon is recycled in a safer and more reliable way.

The present invention provides a device for erasing a used ink ribbon comprising: a heater at the downstream of a printing device, provided at a dye layer side of an ink ribbon and contacting a dye layer of the ink ribbon.

More suitably, the heater is provided on the surface with at least one heating body formed by several linearly arranged heating points.

Preferably, the heater is a cylinder.

More suitably, the erasing device for a used ink ribbon further comprises: a driving device connected to the heater, adapted to drive the heater to rotate around its own axis.

Preferably, the heater is a triangular prism, and is in linear contact or planar contact with the ink ribbon.

Preferably, the heater is a cuboid, and is in linear contact or planar contact with the ink ribbon.

More suitably, the erasing device for a used ink ribbon further comprises: an elasticity adjusting device provided between the heater and a printer body, and the elasticity adjusting device comprises a fixed frame and an elastic member provided between the fixed frame and the heater, and the fixed frame is fixedly connected to the printer body; and the elasticity adjusting device can adjust the sliding of the heater along the fixed frame.

In the technical solution provided by the present invention, the heater is provided at the dye layer side of the ink ribbon, and directly melts the dye remaining on the used ink ribbon and thoroughly erases the remaining information on the ink ribbon, and thus the ink ribbon is recycled in a safer and more reliable way. The device for erasing a used ink ribbon according to the present invention is simple in structure and thus the production cost thereof is reduced greatly.

### BRIEF DESCRIPTION OF THE ACCOMPANYING DRAWINGS

FIG. 1 is a schematic view of the structure of a device for erasing a used ink ribbon provided in the prior art;

FIG. 2 is a schematic view of the use state of the erasing device in the embodiment of the present invention which is used in a thermal transfer printer;

FIG. 3 is a schematic view of the heating body in the embodiment of the present invention;

FIG. 4a is a schematic view of the remaining information on the used segmental of the ink ribbon;

FIG. 4b is a schematic view of the dye layer on the erased segment a2 of the ink ribbon;

FIG. 5 is a schematic view of the structure of the heater 1′ in an embodiment of the present invention whose cross section is triangular;

FIG. 6 is a schematic view of the structure of the heater 1″ in an embodiment of the present invention whose cross section is rectangle;

FIG. 7 is a diagram of the first specific structure of the elasticity adjusting device in an embodiment of the present invention;

FIG. 8 is an A-A section view of FIG. 6;

FIG. 9 is a diagram of the second specific structure of the elasticity adjusting device in an embodiment of the present invention;

FIG. 10 is a diagram of the third specific structure of the elasticity adjusting device in an embodiment of the present invention.

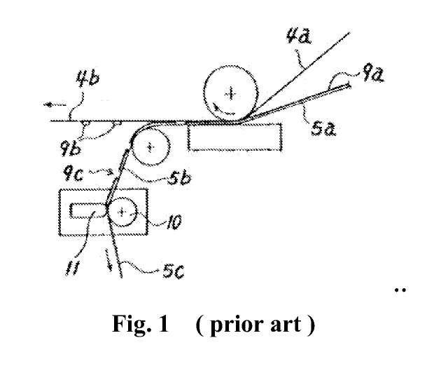

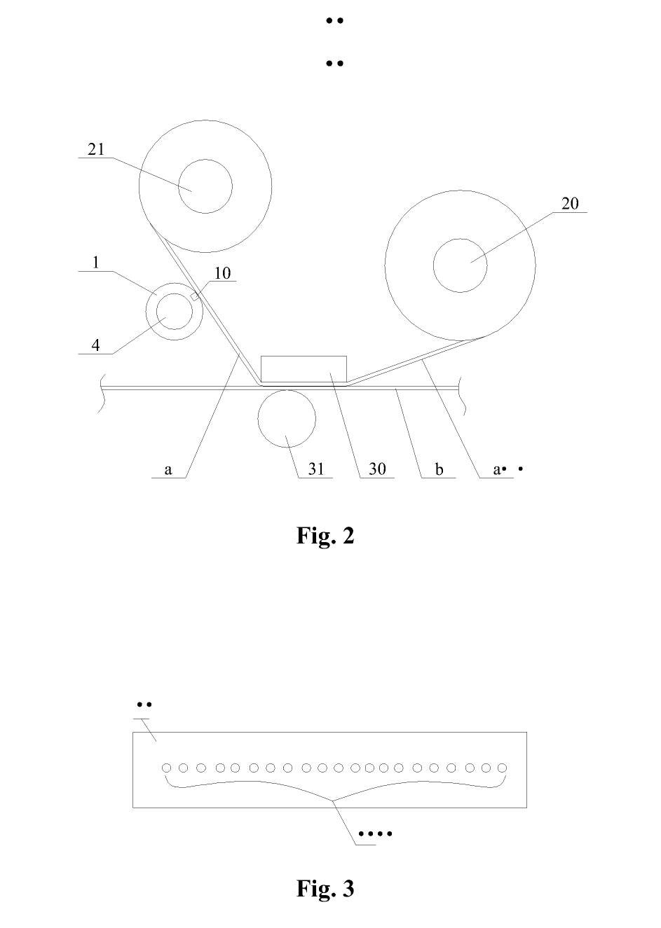

In FIGS. 2-10:
1, 1′, 1″—heater;
10, 10′, 10″—heating body;
1a—guide pole;
11a, 11b, 11c—sliding block;
20—releasing shaft;
21—recycling shaft;
30—printing head;
31—printing roller;
a—ink ribbon, a′—dye layer, a1—used segment of the ink ribbon, a2—erased segment of the ink ribbon;
b—printing medium;
4—driving device;
61, 61a, 61b, 61c—fixed frame;
611a, 611b, 611c—chute; and
62—elastic member, 62a—compressed spring, 62b—torsion spring, 62c—leaf spring.

### DETAILED DESCRIPTION OF THE INVENTION

The embodiments of the present invention will be detailed hereinafter in conjunction with the accompanying drawings of the Specification.

The design idea of the invention lies in that the operation of eliminating the remaining information on the ink ribbon is completed by directly melting and erasing the dye remaining on the ink ribbon through a heating device.

Referring to FIG. 2, it is a schematic view of the use state of the erasing device according to the present invention which is used in a thermal transfer printer.

As shown in FIG. 2, the thermal transfer printer using the erasing device according to the present invention comprises: an erasing device, an ink ribbon recycling device and a printing device; wherein the ink ribbon recycling device mainly comprises a releasing shaft 20 and a recycling shaft 21, and the printing device mainly comprises a printing head 30 and a printing roller 31; the unused ink ribbon a is wound around the releasing shaft 20, the front adge of the ink ribbon a passes through the gap between the printing head 30 and the printing roller 31 after being guided out from the releasing shaft 20, and the used ink ribbon a is wound around the recycling shaft 21, and meanwhile, the printing medium b also passes through between the printing head 30 and the printing roller 31, and the dye layer a′ of the ink ribbon a faces the printing face of the printing medium b; the erasing device comprises a heater 1 which is provided at the downstream of the printing device and is in contact with the dye layer a′ side of the ink ribbon a and which is provided at the surface with at least one heating body 10 formed by several linearly arranged heating points. The heating of the heating body 10 can be controlled so that it melts the dye layer a′ of the ink ribbon a. The dimension that the heating body 10 contacts the dye layer a′ in the lateral direction of the ink ribbon a is larger than the dimension of the remaining information region on the lateral direction of the ink ribbon a, and thus it is ensured that the heating body 10 contacts the region of the ink ribbon where the remaining information is located, so as to erase the information remaining on the ink ribbon a and thus realize eliminating the remaining information on the used ink ribbon, and more suitably, the lateral dimension of the heating body 10 on the ink ribbon a is larger than the width of the ink ribbon a.

It is specifically noted that the ink ribbon recycling device, the printing device and the other parts of the thermal transfer printer are not detailed herein since the ink ribbon recycling device and the printing device are not the inventive points of the present invention.

During the printing, when the used segment a1 of the ink ribbon passes the heater 1 at the downstream of the printing device, the dye layer a′ with remaining information adhered thereto is melted by heating; when a relative movement occurs between the ink ribbon a and the heater 1, the heater 1 erases the dye layer which is melted by heating and then erases the information remaining on the ink ribbon a, thereby realizing eliminating the information remaining on the used ink ribbon.

Compared with the device for erasing a used ink ribbon provided by JP63230386 as described in the Background Art, the present invention abandons the scraper 11 which can easily damage the base of the ink ribbon and the receiving plate that needs to be cleaned frequently, and thus it is simple and reasonable in structure and then reduces the production and maintenance costs of the erasing device.

For the erasing effect of the present invention, please refer to FIG. 3a and FIG. 3b, and FIG. 3a is a schematic view of the remaining information on the used segment a1 of the ink ribbon, and FIG. 3b is a schematic view of the dye layer remaining on the erased segment a2 of the ink ribbon.

Upon comparison, as shown in FIG. 3a, the remaining information on the used segment a1 of the ink ribbon can be clearly seen; as shown in FIG. 3b, after being erased by the present invention, the remaining dye on the erased segment a2 of the ink ribbon is rearranged and the remaining information thereon is erased completely.

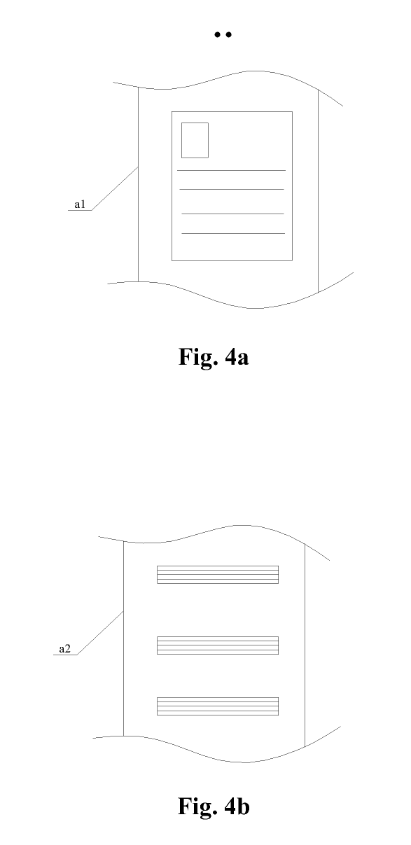

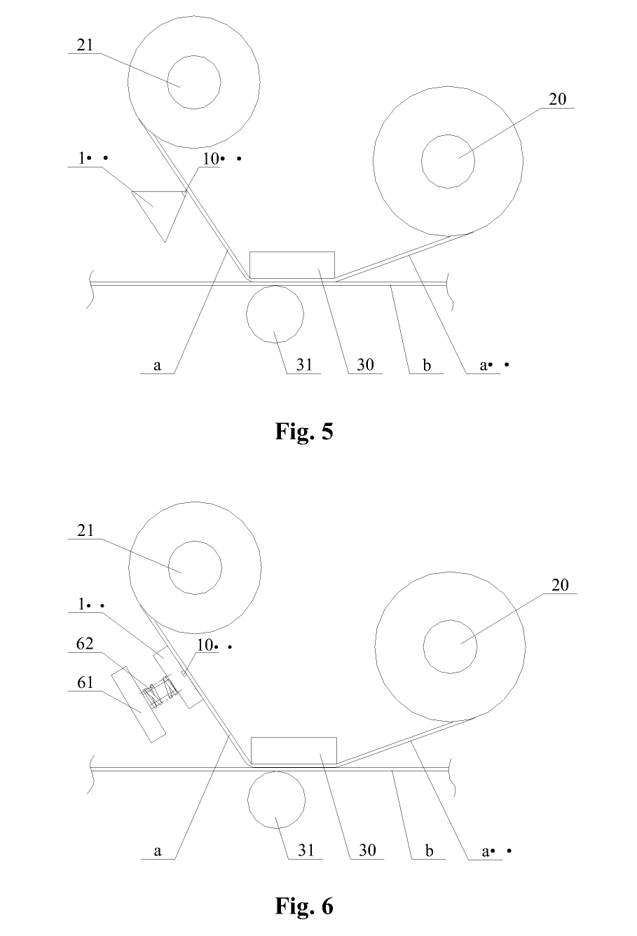

It is understandable that the shape of the cross section of the heater 1 of the present invention does not affect the implementation of the technical solution, and this solution can be realized by ensuring a reliable contact between the heater 1 and the ink ribbon a. The present invention provides three preferable shapes of the heater 1, the heater 1 being a cylinder, as shown in FIG. 2, with a cross section of a circular shape; the heater 1′ being a triangular prism, as shown in FIG. 4, with a cross section of a triangle shape, and a heating body 10″ being provided at a corner of the triangular prism contacting the ink ribbon; the heater 1″ being a cuboid, as shown in FIG. 5, with a cross section of a rectangle shape, and a heating body 10″ being provided at the surface of the rectangle contacting the ink ribbon.

Wherein, the heater in a shape of triangular prism or cuboid can be in either linear or planar contact with the ink ribbon a as long as the use demand is met and the operation of erasing the used ink ribbon a is realized.

When the heater 1 is a cylinder, multiple heating bodies 10 can be provided evenly on the surface of the cylinder. Meanwhile, the device for erasing a used ink ribbon provided by the present invention further comprises a driving device 4 configured to drive the heater 1 to rotate around its own axis. Thus, with the straight-line movement of the ink ribbon a, the heater 1 rotates, and then the outer surface of the heater 1 participates in heating and erasing in a circular manner, thereby making the erasing effect better.

Wherein, the driving device 4 can separately uses an electric motor for driving, and a DC electric motor or an AC electric motor can be selected; in addition, the electric motor for the paper feeding or ink ribbon feeding can also be used, and power can be transmitted to the heater 1 via gear arrangement, and a person skilled in the art can completely realize the arrangement and setting of the above gear transmission mechanism, which is thus omitted here.

It needs to be explained that the ink ribbon recycling device can provide tension during the moving of the ink ribbon and combines at the same time the pre-pressure between the heater 1 and the ink ribbon a, and thus, the heater 1 and the ink ribbon a are in a reliable press contact state therebetween. Due to the normal consumption of the thermal transfer printer, the ink ribbon and/or the ink ribbon recycling device will be replaced on demand, and different base materials of the ink ribbon and the mounting error of the ink ribbon recycling device will directly affect the value of the tension during the movement of the ink ribbon. Hence, in a situation of changeable tensions of the ink ribbon, it cannot ensure the reliable press contact state between the heater 1 and the ink ribbon a if the heater 1 is fixed at a relative position vertical to the direction of the ink ribbon a.

Due to the above reasons, the device for erasing a used ink ribbon provided by the present invention further comprises an elasticity adjusting device provided between the heater and the printer body and configured to adjust a relative position between the heater 1 and the ink ribbon a. As shown in FIG. 5, the elasticity adjusting device comprises a fixed frame 61 and an elastic member 62 provided between the fixed frame 61 and heater 1, and the fixed frame 61 is fixedly connected to the printer body. Under the effect of the spring force of the elastic member 62, the heater 1 can float with respect to the fixed frame 61.

To detail the structure of the elasticity adjusting device, please refer to FIG. 6, and it is a diagram of the first specific structure of the elasticity adjusting device of the present invention.

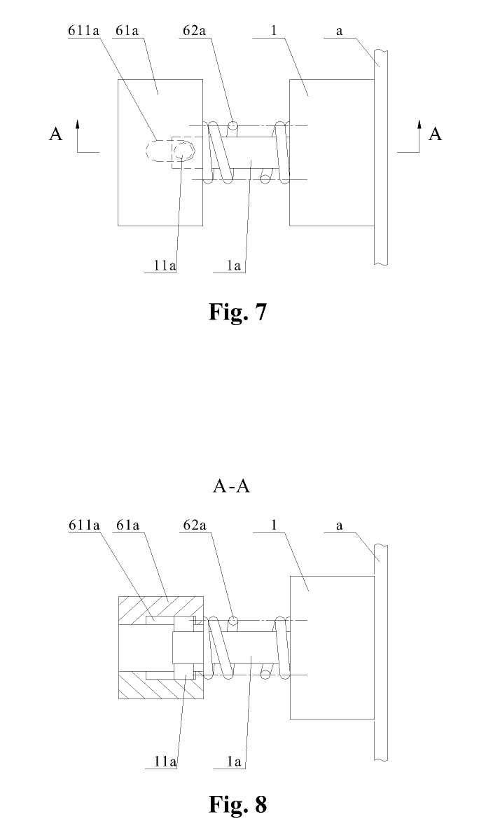

As shown in FIG. 6, the elastic member is a compressed spring 62a, and the heater 1 is fixedly provided thereon with a guide pole la which is provided with a sliding block 11a at the end portion; the compressed spring 62a is placed around the guide pole 1a and respectively presses against the heater 1 and the fixed mount 61a at the two end faces. It is specially explained that the sliding block 11a can also be provided at the two end portions of the heater 1. Further, as shown in FIG. 7, it is an A-A section view of FIG. 6.

As shown in FIG. 7, the fixed frame 61a is grooved therein with a chute 611a whose lengthwise direction is vertical to the advancing direction of the ink ribbon a; the sliding block 11a at the end portion of the guide pole 1a is provided within the chute 611a and can slide within the same. The key part of the elasticity adjusting device is the compressed spring 62a, and the pre-pressure between the heater 1 and the ink ribbon a can be ensured by setting parameters such as the rigidity of the compressed spring 62a.

Referring to FIG. 8, it is a diagram of the second specific structure of the elasticity adjusting device according to the present invention.

As shown in FIG. 8, the elastic member is a torsion spring 62b, and the fixed frame 61b is grooved therein with a chute 611b whose lengthwise direction is vertical to the advancing direction of the ink ribbon a; the sliding block 11b at the two end portions of the heater 1 is provided within the chute 611b and can slide within the same. The torsion spring 62b is fixedly connected to the fixed frame 61b at one end and presses against the sliding block 11b at the other end, which serves to support the heater 1, and then by means of the elastic force of the torsion spring 62b, the pre-pressure between the heater 1 and the ink ribbon a is ensured.

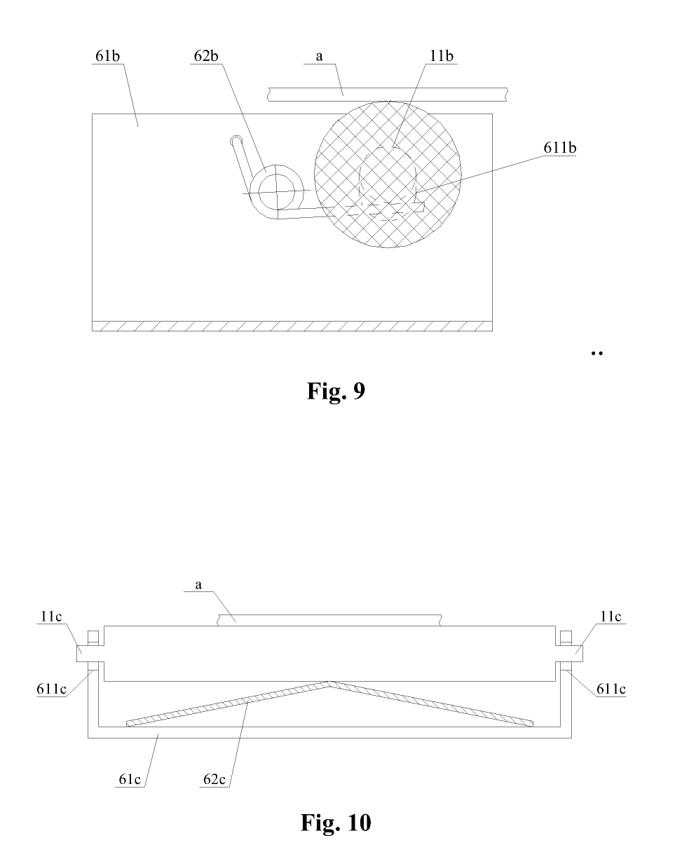

Referring to FIG. 9, it is a diagram of the third specific structure of the elasticity adjusting device according to the present invention.

As shown in FIG. 9, the elastic member is a leaf spring 62c, and the fixed frame 61c is grooved therein with a chute 611c whose lengthwise direction is vertical to the advancing direction of the ink ribbon a; the sliding block 11c at the two end portions of the heater 1 is provided within the chute 611c and can slide within the same. The leaf spring 62c is provided between the fixed frame 61c and the heater 1, and then by means of the elastic force of the leaf spring 62c, the pre-pressure between the heater 1 and the ink ribbon a is ensured.

In the above embodiments, due to the arrangement of the elasticity adjusting device, the elastic member can be used to automatically and adaptively adjust the pressure between the heater and the ink ribbon, so that the contact between the heater and the ink ribbon is more reliable and fine erasing effect can be obtained.

One point is specially noted that the heater position adjusting device can be applied to different shapes of heaters and are not only limited to the heaters in a cylinder or cuboid shape as shown herein.

All in all, the working process of the present invention is described as follows: first, the printing head 30 heats and then melts the dye of the dye layer a′ adhered to the ink ribbon a and transfers the same to the printing medium b to form characters and/or patterns; when the used ink ribbon a is passing the heater 1, the heater 1 heats and then melts and erases the dye remaining on the ink ribbon a, and thus eliminates the information remaining on the ink ribbon a; and finally, the used ink ribbon a is wound around the recycling shaft 21, and the recycling is completed.

The above described is just preferable embodiments of the present invention, and it should be indicated that one skilled in the art could make improvements and modifications without departing from the principle of the present invention which should also be contained within the scope of protection of the present invention.

1. A device for erasing a used ink ribbon comprising a heater, wherein the heater is provided at a dye layer side of an ink ribbon at the downstream of a printing device and is in contact with a dye layer of the ink ribbon.

2. The device for erasing a used ink ribbon according to claim 1, wherein the heater is provided on the surface with at least one heating body formed by several linearly arranged heating points.

3. The device for erasing a used ink ribbon according to claim 2, wherein the heater is a cylinder.

4. The device for erasing a used ink ribbon according to claim 3, further comprising:
a driving device connected to the heater, adapted to drive the heater to rotate around its own axis.

5. The device for erasing a used ink ribbon according to claim 2, wherein the heater is a triangular prism, and is in linear contact or planar contact with the ink ribbon.

6. The device for erasing a used ink ribbon according to claim 2, wherein the heater is a cuboid, and is in linear contact or planar contact with the ink ribbon.

7. The device for erasing a used ink ribbon according to claim 1, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.

8. The device for erasing a used ink ribbon according to claim 7, wherein the elastic member is a compressed spring.

9. The device for erasing a used ink ribbon according to claim 7, wherein the elastic member is a torsion spring.

10. The device erasing for a used ink ribbon according to claim 7, wherein the elastic member is a leaf spring.

11. The device for erasing a used ink ribbon according to claim 2, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.

12. The device for erasing a used ink ribbon according to claim 3, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.

13. The device for erasing a used ink ribbon according to claim 4, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.

14. The device for erasing a used ink ribbon according to claim 5, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.

15. The device for erasing a used ink ribbon according to claim 6, further comprising an elasticity adjusting device provided between the heater and a printer body, the elasticity adjusting device comprising a fixed frame and an elastic member provided between the fixed frame and the heater, and the fixed frame being fixedly connected to the printer body; and the elasticity adjusting device being able to adjust the sliding of the heater along the fixed frame.
